(19) United States
(12) Patent Application Publication
(10) Pub. No.: US 2007/0194550 A1
(43) Pub. Date: Aug. 23, 2007

(54) Vehicle Wheel Suspension System

(76) Inventor: Frank Wadelton, Bellows Falls, VT (US)

Correspondence Address: Brian M. Dingman, Esq.;Mirick, O'Connell, DeMallie & Lougee, LLP, 1700 West Park Drive, Westborough, MA, 01581, US

(21) Appl. No.: 11/677,101

(22) Filed: Feb. 21, 2007

Related U.S. Application Data
(60) Provisional application No. 60/775,584, filed on Feb. 22, 2006.

(51) Int. Cl. B60G 9/00; B60G 21/05; B62M 7/00

(52) U.S. Cl. 280/124.116; 280/124.128; 180/227

(57) ABSTRACT

A compressible link suspension system for a wheel of a multi-wheel vehicle that has a frame and an axle for the wheel. The suspension system has upper and lower double-ended pivot members indirectly coupled to the wheel axle that isolate the rear wheel from the frame. The suspension system also has a shock absorber connected between the pivot members so as to be compressible from the top and the bottom via pivoting of the pivot members.

### CROSS-REFERENCE TO RELATED APPLICATION

This application is based upon and claims the benefit of priority from U.S. Provisional Application Ser. No. 60/775,584 filed on Feb. 22, 2006, the entire contents of which are incorporated by reference herein.

### FIELD OF THE INVENTION

This invention relates to a suspension for one or more driven wheels of a wheeled vehicle such as a bicycle or a motor vehicle.

### BACKGROUND OF THE INVENTION

Wheeled vehicles specifically built for off-road riding frequently have some type of suspension apparatus allowing movement of the wheels in relation to the frame. With a bicycle, for example, the movement is relative to human contact points of the bicycle such as hands, pedals and saddle. The direction of wheel travel and the rate of return spring pressure is determined by the mechanical attributes of the machine itself. Some, by way of a single pivot located at or near the center of the frame, hinge on the pivot in a simple fashion, with the vehicle weight supported by a shock. Upon contacting a bump, the wheel travels in a path predicted by the location of the pivot and the amount of shock travel. Other more complex designs have multiple links and brackets providing a path made of adjoining arcs and lines. In a bicycle, the direction of wheel travel best for pedaling efficiency is not the same as needed for hitting bumps without loss of speed.

The ideal path for the wheel, for optimal performance of the driven wheel, is one that varies its relation to the vehicle in such a way as to adjust its vertical relation to the majority of the vehicle until the obstacle has passed so as not to disrupt the direction or cause loss of speed or irregular motive cadence through slow upward acceleration.

When a vehicle impacts a bump of modest size or at slow speeds, the wheel moves upward to compensate for the profile of the terrain, and upon passing the bump, returns to its original position. As the speed of the vehicle increases or the bump becomes more abrupt, the wheel must accelerate upward more quickly. If the path of wheel travel is angled rearwardly away from the direction of vehicle travel, the wheel can accelerate at a slower speed, which helps preserve contact between the earth and the wheel while the wheel follows the contours of the terrain. This minimizes upset to the direction of movement or speed.

### SUMMARY OF THE INVENTION

This invention features in one embodiment a bicycle frame with a front section made up of a top tube, a head tube, a down tube, a bottom bracket shell for mounting of the cranks or transmission and an up tube, all connected in a generally triangular shape. Also included in construction of the front section are fitments for bicycle components such as but not limited to seat, handlebars, front suspension and wheel assembly. Located above the bottom bracket is a lower main pivot and the upper main pivot. Attached to the lower main pivot by bearing and bolt is a lower bell crank, to which is attached a damper and spring, and a swing arm, by three pivots in a triangular pattern, with the shock mounted rearward of the main pivot in such a way as to allow the downward force of the shock to pull the swing arm forward by rotation of the bell crank in a counter-clockwise direction. The swing arm's opposite end attaches to the wheel via a removable axle or quick release lever. Also comprising the swing arm, above and forward of the wheel axle, is the rear pivot where a pair of bolts and bearings attaches the shock stay to an upper bell crank. The upper bell crank is attached to the shock or spring damper by bolt and bearing. The respective arms being held in a downward and forward way support the weight of the vehicle and rider and provide suspension and control.

This invention has as one attribute the ability, upon contacting a bump, to accomplish instantaneous and temporary rearward wheel movement for quicker response with less operator feedback. A vertical action of the suspension immediately following the rearward movement of the wheel pulls the wheel forward with little shock movement. The demand of the bump controls the way the suspension responds to the bump.

The forces of gravity and variations in the terrain are separated by direction of load. Gravity is a vertical load requiring a vertical wheel path that in the embodiments is controlled by a shock stay and upper rocker. Large or obtuse objects cause a rearward movement of the wheel altering the wheel path by forcing a lower rocker to rotate, actuating the shock from the bottom and altering the wheel path to suit the profile of the object.

In another embodiment, the invention features a bicycle or other wheeled vehicle consisting of a frame and rear suspension comprising a swing arm with one end coupled to the rear wheel and the other end pivotally coupled to a lower bell crank. The lower bell crank is pivotally coupled to the frame, and also coupled to a shock. The swing arm is attached in such a way as to limit the degree of rotation-causing action at the main pivot. Attached to the swing arm on both sides of the wheel, and near the wheel axle, is a shock stay. The shock stay is pivotally coupled to an upper bell crank in such a way as to apply force to the shock. The upper bell crank is pivotally coupled to the frame, and coupled to the top of the shock. Force applied to the shock through the upper bell crank is transmitted to the lower bell crank in such a way as to hold the lower bell crank at one end of its rotational travel.

As the bicycle or other wheeled vehicle is ridden or driven in normal conditions on a smooth roadway, it preferably pivots only slightly and on the forward end of the swing arm. While pedaling the bicycle, a variable force know as chain torque drives the wheel forward, forcing the swing arm forward. The forward motion of the swing arm creates upward pressure on the lower bell crank and simultaneously neutralizes downward force from the pedal while also decreasing leverage on the shock. The forward force then is the cause for forward motion with no downward movement of the bicycle.

As the bicycle or other wheeled vehicle is ridden or driven over bumps of modest size, the suspension is caused to articulate on the forward swing arm pivot and travel in an upward direction, maintaining a consistent chain length. As the bicycle or other wheeled vehicle is ridden or driven over more abrupt bumps, sudden rearward movement is caused, which causes rotation of the lower bell crank. This in turn causes a reaction by way of movement of the shock. After momentary rearward then upward movement, as the wheel clears the bump, force in the upward direction causes movement of the upper bell crank, causing movement of the shock, which rotates the lower bell crank, returning the lower bell crank to its most counter-clockwise position.

The vehicle, upon contacting any bump of manageable size and shape, will react in such a way as to not impede the movement of its mass or its speed by responding in a way that is most appropriate within its mechanical limitations. The bicycle, upon contacting bumps while pedaling, will allow smooth pedaling cadence and best performance through minimum suspension feedback by allowing on-demand suspension movement and direction. Under hard braking, the bicycle will have rearward wheel movement, thus increasing braking efficiency.

This invention features a compressible link suspension system for a wheel of a multi-wheel vehicle that has a frame and an axle for the wheel (such as a bicycle or automotive vehicle, for example), comprising upper and lower double-ended pivot members coupled directly or indirectly to the wheel axle, that isolate the rear wheel from the frame, and a shock absorber connected between the pivot members. The upper and lower pivot members may comprise rocker arms, and in a more specific embodiment may be bell cranks.

The upper and lower pivot members may be part of a wheel frame section that is coupled to the wheel axle and that defines upper and lower pivot points that are spaced from the wheel axle. The upper pivot member may comprise an upper rocker arm pivotally coupled to the upper pivot point, pivotally coupled to the shock absorber, and pivotally coupled to the vehicle frame, and the lower pivot member may comprise a lower rocker arm lever pivotally coupled to the lower pivot point, pivotally coupled to the shock absorber, and pivotally coupled to the vehicle frame.

The wheel frame section may further comprise a swing arm between the lower rocker arm and the wheel axle, and a shock stay located above the swing arm and between the upper rocker arm and the wheel axle. The upper rocker arm may be coupled to the vehicle frame at a location that is above that of the upper pivot point. The location at which the upper rocker arm is coupled to the vehicle frame may be below the location at which the upper rocker arm is coupled to the shock. The location at which the upper rocker arm is coupled to the vehicle frame may be between the locations where it is coupled to the upper pivot point and where it is coupled to the shock absorber. The upper rocker arm rotation in one direction about its pivot on the vehicle frame may cause compression of the shock.

The lower pivot point may be below the location at which the lower rocker arm is coupled to the vehicle frame. The location at which the lower rocker arm is coupled to the shock may be between the locations where it is coupled to the lower pivot point and where it is coupled to the vehicle frame. The lower rocker arm rotation in one direction about its pivot on the vehicle frame may cause compression of the shock. The rotation of the lower rocker arm relative to the vehicle frame may be limited by its contact with the vehicle frame. The lower rocker arm may have three pivots that define a triangle. The shock may be coupled to the lower rocker arm closer to the wheel than the location at which the lower rocker arm is coupled to the vehicle frame. Downward force by the shock may rotate the lower rocker arm about the vehicle frame pivot and pull the swing arm forward.

In one embodiment, the upper pivot member comprises an upper rocker arm pivotally coupled to the upper pivot point, pivotally coupled to the shock absorber, and pivotally coupled to the vehicle frame, the lower pivot member comprises a lower rocker arm pivotally coupled to the lower pivot point, pivotally coupled to the shock absorber, and pivotally coupled to the vehicle frame, and the wheel frame section further comprises a parallel bar pivoting linkage between the vehicle frame and the lower rocker arm. In this case, the wheel frame section may further comprise a connecting rod connecting the parallel bar linkage to the upper rocker arm.

Also featured in the invention is a suspension system for a wheel of a multi-wheel vehicle that has a frame (such as a bicycle or automotive vehicle, for example), comprising a wheel frame section assembly coupled to the wheel axle, and defining upper and lower connection points that are spaced from the wheel axle, a shock absorber, an upper actuator coupled to the upper connection point and also coupled to the shock absorber, the upper actuator adapted to compress the shock absorber in a first direction, and a lower actuator coupled to the lower connection point and also coupled to the shock absorber, the upper actuator adapted to compress the shock absorber in a second direction.

Further featured is a compressible link suspension system for a wheel of a multi-wheel vehicle that has a frame and an axle for the wheel (such as a bicycle or automotive vehicle, for example), comprising pivoting structure coupled to the wheel axle that isolates the rear wheel from the frame, and a shock absorber connected between spaced portions of the pivoting structure, wherein the pivoting structure is adapted to compress the shock from two directions. The pivoting structure and shock may be adapted to allow the wheel to move both up and down, and backward and forward, relative to the frame. When the wheel encounters an abrupt obstruction, the wheel may move both backward and up simultaneously such that the axle traverses a first arcuate path, from a beginning point to an end point. When the wheel has passed over the abrupt obstruction, the wheel may move both forward and down simultaneously such that the axle traverses a second arcuate path, from the end point to the beginning point. The first and second arcuate paths may not be coincident, and may together define a closed generally elliptical shape.

### BRIEF DESCRIPTION OF THE DRAWINGS

Other objects, features and advantages will occur to those skilled in the art from the following description of the preferred embodiments, and the accompanying drawings, in which:

FIG. 1 is a schematic diagram of one preferred embodiment of the inventive vehicle wheel suspension system, accomplished in a bicycle, showing the bike frame in the normal position, while moving over a flat surface.

FIGS. 2-4 are schematic diagrams showing three progressive stages of movement of the vehicle wheel suspension system of FIG. 1.

FIG. 5 is a schematic diagram of another embodiment of the invention, accomplished for a wheel of a motor vehicle.

FIGS. 6-9 are schematic diagrams showing progressive stages of movement of the vehicle wheel suspension system of FIG. 5.

### DETAILED DESCRIPTION OF PREFERRED EMBODIMENTS OF THE INVENTION

This invention may be accomplished in a compressible link suspension system for a wheel of a multi-wheel vehicle that has a frame, and an axle for the wheel. The suspension system has upper and lower double-ended pivot members (typically rocker arms that may be bell cranks) indirectly coupled to the wheel axle; the pivot members isolate the rear wheel from the frame. The suspension system also has a shock absorber connected between the pivot members. This arrangement allows the shock to be compressed from either end.

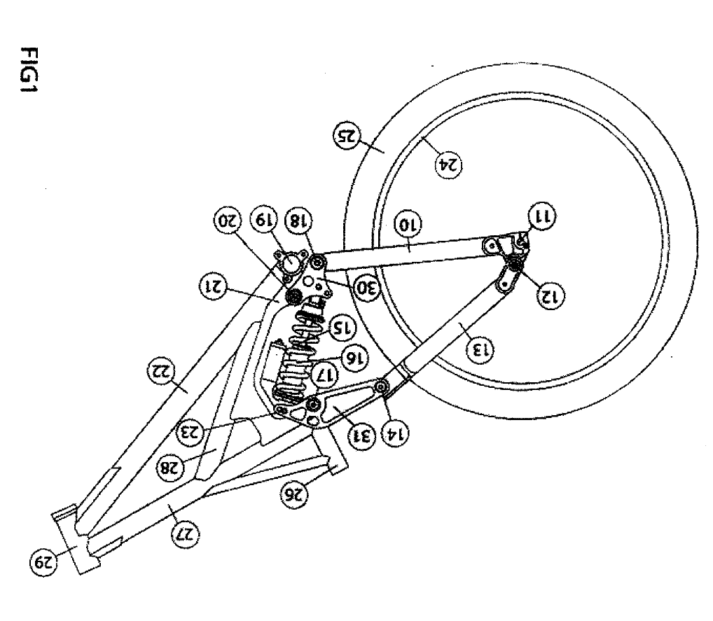

One preferred embodiment of the invention, adapted specifically for off-road bicycles, is shown in FIGS. 1-4 of the drawings. Comprising a front triangle is fitments for holding the seat 26, top tube 27, head tube 29 for holding the fork and handle bars, down tube 22 with bottom bracket shell 19 for cranks or transmission attached to its end, and the up tube 28. The triangle can be made either with tubes, or by way of monocoque sheet metal design, for example. There are also mountings for two separate pivot points, an upper pivot point 17, and a lower pivot point 20. In the embodiment, frame pivot mounting plates 21 define these pivot points. The inventive suspension comprises upper 31 and lower 30 pivot members that are pivotally coupled to the frame pivot points, pivotally coupled to the shock, and pivotally coupled to members 10 and 13. In this embodiment, members 30 and 31 are rocker arms in the form of bell cranks. The suspension also comprises swing arm 10, shock stay 13, and a shock comprising damper 15 and spring 16. Also united by threaded connection or press fit, for example, are pedal axle and cranks, fork and handle bars, wheels and tires and other devices or accoutrements such as drive chain gears and related controls, not all of which are shown in these drawings for the sake of clarity in understanding the invention.

Swing arm 10, FIG. 1, is coupled at one end to axle 11 for the wheel assembly comprising rim 24 and tire 25, and is mounted pivotally at the other end 18 to one end of lower bell crank 30. Swing arm 10 is held in relation to the frame by downward force on the shock. Bell crank 30 pivots about axis 20 relative to the fixed frame. As bell crank 30 pivots clockwise in this view about pivot axis 20, the opposing end of swing arm 10 at pivot 18 rises in a vertical fashion. At its other end near the wheel axle 11, swing arm 10 through shock stay 13 is pivotally coupled at pivot 14 to the rearmost portion of upper bell crank 31, for example by bearing and bolt. The subsequent force applied through the shock keeps lower bell crank 30 rotated against the frame, which acts as a lower bell crank rotation limit (stop).

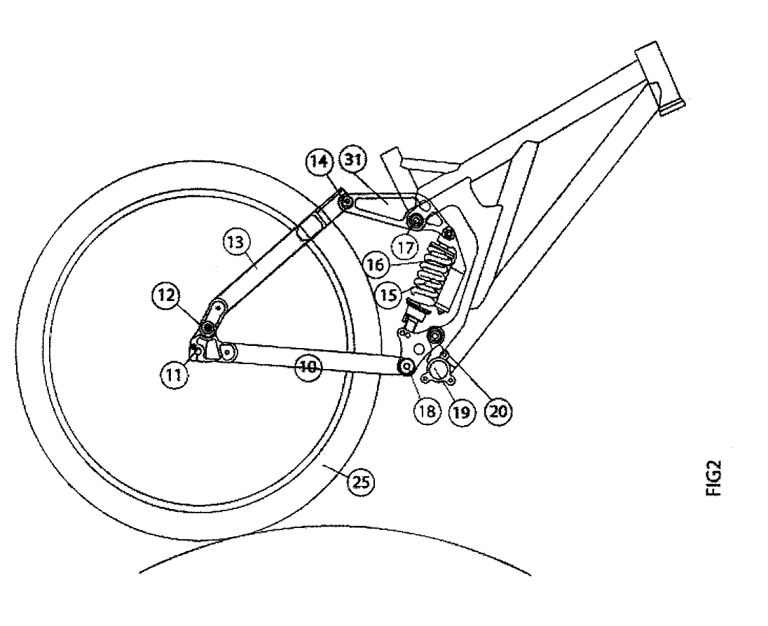

As evident in FIG. 2, coming in contact with a gradual bump, the upward force on the wheel assembly is greater than the rearward force. This moves swing arm 10 rotationally about points 18 and 14, while causing little to no rotation of lower pivot arm bell crank 30 at pivot 20.

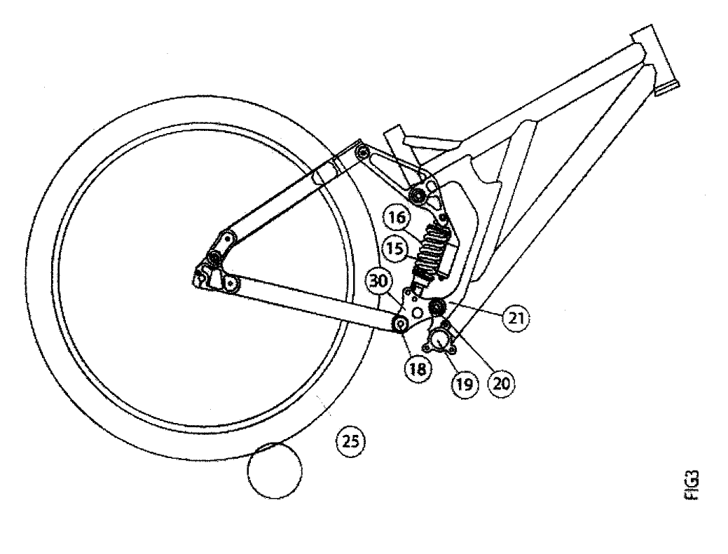

As evident in FIG. 3, in the case of more abrupt transitions that contact the wheel assembly at a position higher in altitude around the front circumference of the wheel, the wheel assembly is pushed in a more rearward than upward direction, resulting in a greater rearward force on swing arm 10. This causes rotation of bell crank 30 at locations 18 and 20, thus forcing the shock to compress from the bottom. This temporary rearward movement and subsequent compression of the shock allows the wheel assembly to rise over the object. At the point that the bicycle has progressed forward, the upward force is increased and the rearward force decreased.

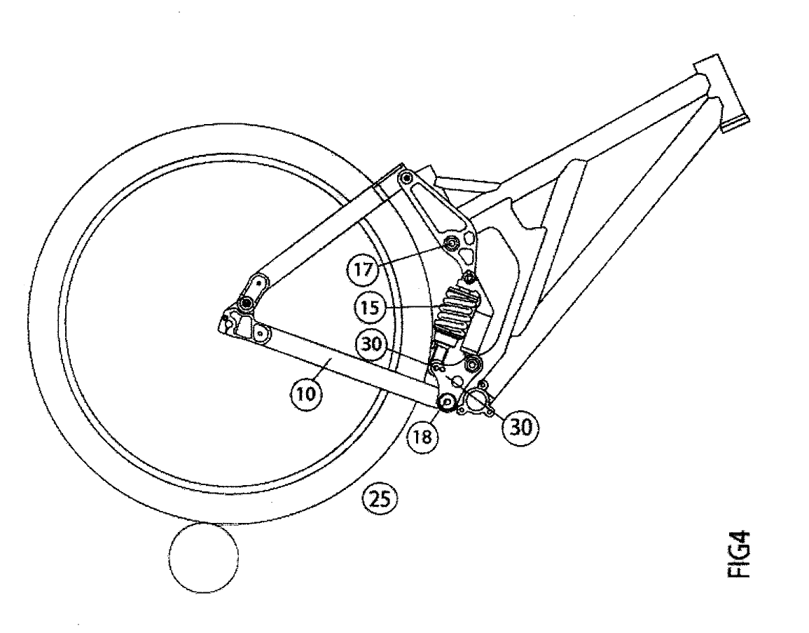

As evident in FIG. 4, once over the bump, counter-clockwise rotation of lower bell crank 30 at a point of reduced rearward force and increased upward force will move swing arm 10 and the wheel assembly forward. Upon passing the object completely, the pressure held by force in the shock 15, 16 will return the assembly to the position of FIG. 1, to support the vehicle weight and resistance to gravity.

This embodiment of the invention is able to adjust the path of wheel travel to meet the demands of the variations in surfaces commonly traversed on a bicycle of this type. The invention accomplishes the use of a single shock, with application of compressive forces to either end of the shock, with each direction serving a specific purpose in the suspension action.

A bicycle embodying the invention, thus a bicycle incorporating a rear wheel suspension design as described and illustrated in the foregoing, combines a functional structure with a variable wheel path and suspension action, and offers the possibility for increased performance and functional improvement.

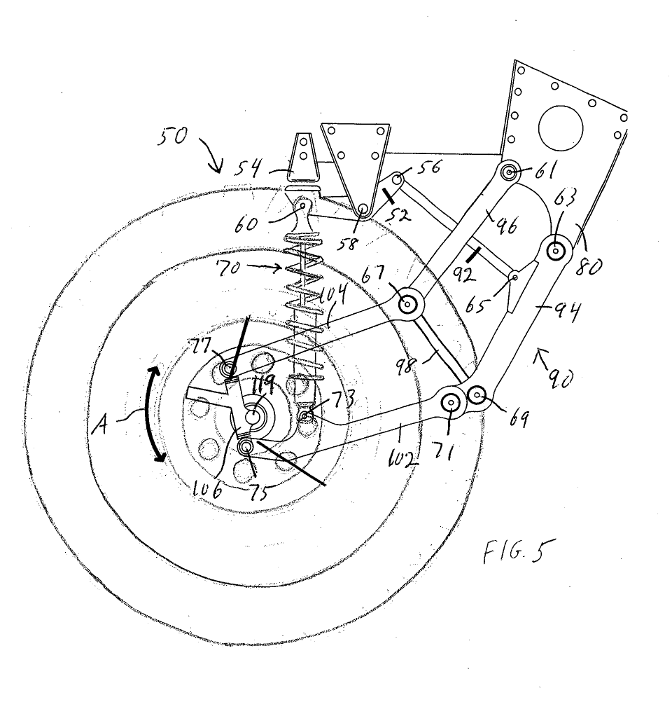

A second preferred embodiment, detailing an embodiment of the invention adapted for a wheel of a motor vehicle (e.g. a truck or a vehicle with a wheel-driven track-based motive methodology such as a tank) is depicted in FIGS. 5-9. Compressible link suspension system 50 lies between wheel W and vehicle frame 80. Wheel W is shown in phantom in the drawings, as it is not part of the invention. Upper pivot member (rocker arm) 52 and lower pivot member (rocker arm) 102 have shock 70 coupled between them. Stop 54, which is attached to frame 80, limits rotation of rocker arm 52 about upper pivot point 58 in one direction. Steering can be accomplished through linkage 106.

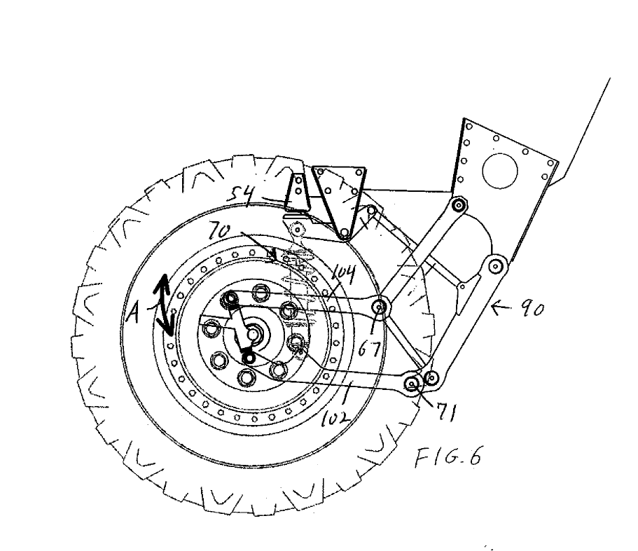

Under normal flat-terrain driving conditions as shown in FIG. 5, the vehicle weight, by way of shock 70 attached to rocker 52, is resting on stop 54. Rod 92 (pivotable about points 56 and 65) prevents rotation of parallel bar linkage 90, comprising arms 94 and 96, about pivots 61 and 63. This maintains link 98 in position as well. Lower rocker arm 102 and arm 104 can still rotate about pivots 71 and 67, respectively, to allow for vertical motion of wheel W, which is shown in FIG. 6, in which wheel W has moved vertically in the direction of arrow A. Linkage 90 remains in place, and arms 102 and 104 have rotated clockwise, thereby compressing shock 70.

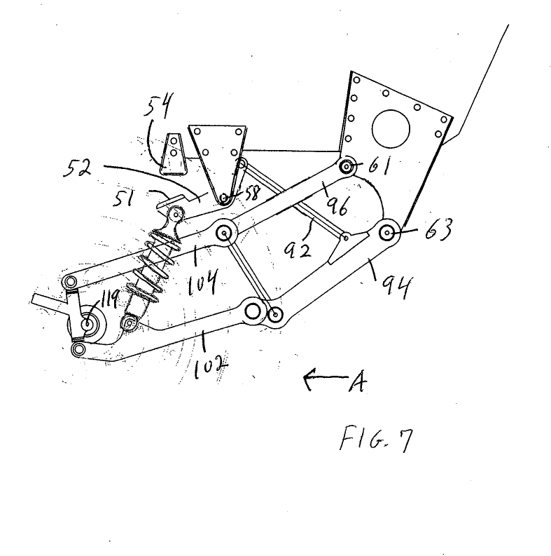

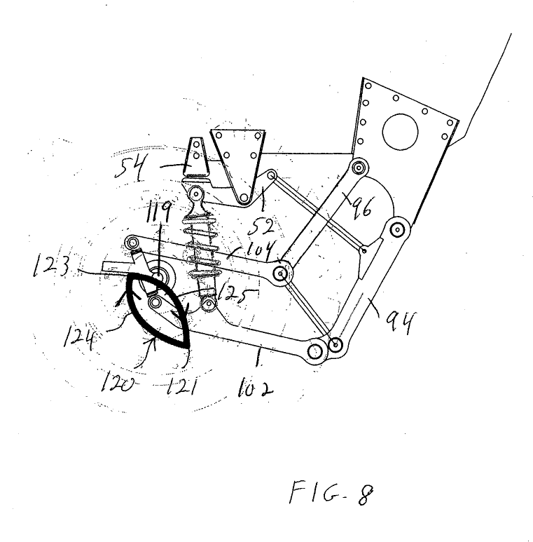

The second degree of freedom of this embodiment of the inventive suspension system is illustrated in action in FIGS. 7 and 8. This occurs when a more abrupt obstruction such as a rock is encountered, which contacts the front of the wheel higher in altitude, creating a backward force on the wheel in the direction of arrow A, FIG. 7. This force causes arms 94 and 96 to rotate clockwise about points 63 and 61, respectively. This moves rod 92, causing arm 52 to rotate counterclockwise about pivot 58. This compresses shock 70 from the top.

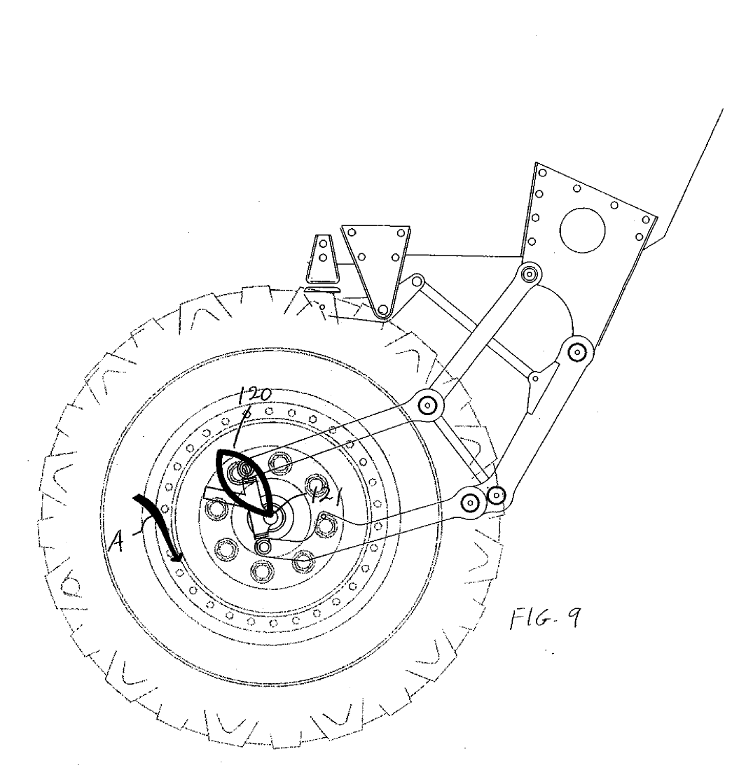

When wheel W has cleared the object, the force on the wheel is reduced, causing shock 70 to force rocker 52 to pivot about point 58 in a clockwise direction. This pushes rod 92, which rotates linkage 90 in a counterclockwise direction back to its normal position shown in FIG. 5. The shock force also rotates arms 102 and 104 in a clockwise direction about points 71 and 67, respectively. These actions roll wheel W down and forward back to its starting, most forward position 121, FIGS. 8 and 9.

FIG. 8 shows closed, generally elliptical axle travel path 120 comprising two intersecting arcuate line segments, including first arcuate segment 124 along which the end of axle 119 moves from its normal, flat terrain starting point 121 to its highest, most rearward end point 123, and different, second arcuate segment 125 along which the end of axle 119 moves from end point 123 back to beginning point 121. In FIG. 8, axle 119 has just begun its travel along path 125 toward point 121. FIG. 9 shows the wheel fully returned to its starting point 121 after traversing path 125.

### List of Numbers Used in FIGS. 1-4

10 Swing arm
11 Rear axle
12 Rear pivot location
13 Shock stay
14 Shock stay to upper bell crank pivot location
15 Damper
16 Spring (damper 15 and spring 16 are collectively referred to as a “shock”)
17 Upper bell crank pivot location/upper frame pivot location
18 Forward swing arm pivot location/lower bell crank pivot location
19 Bottom bracket shell, attachment location for crank axle or transmission
20 Lower frame pivot location/lower bell crank to frame pivot location
21 Frame pivot mounting plates
22 Down tube
23 Upper shock mount to upper bell crank pivot location
24 Rear rim
25 Rear tire (rim 24 and tire 25 together are also known as a “wheel assembly”)
26 Seat mount tube
27 Top tube
28 Up tube
29 Head tube
30 Lower bell crank
31 Upper bell crank

### List of Numbers Used in FIGS. 5-9

50 compressible link suspension system
52 upper rocker arm
54 stop
56 pivot
58 pivot
60 pivot
61 pivot
63 pivot
65 pivot
67 pivot
69 pivot
70 shock
71 pivot
73 pivot
75 pivot
77 pivot
80 vehicle frame
90 parallel bar linkage
92 connecting rod
94 arm
96 arm
98 link
102 lower rocker arm
104 arm
106 steering linkage
119 axle
120 axle travel path
121 axle beginning point
123 axle end point
124 path segment
125 path segment
A direction of travel
W wheel

Although specific features of the invention are shown in some figures and not others, this is for convenience only, as the features may be combined in other manners, in accordance with the invention.

The use of any and all examples, or exemplary language (e.g., “such as”) provided herein, is intended merely to better illustrate the invention and does not pose a limitation on the scope of the invention.

A variety of modifications to the embodiments described herein will be apparent to those skilled in the art from the disclosure provided herein. Thus, the invention may be embodied in other specific forms without departing from the spirit or essential attributes thereof.

What is claimed is:

1. A compressible link suspension system for a wheel of a multi-wheel vehicle that has a frame and an axle for the wheel, comprising:
upper and lower double-ended pivot members coupled to the wheel axle, that isolate the rear wheel from the frame; and
a shock absorber connected between the pivot members.

2. The suspension system of claim 1 in which the upper pivot member comprises a rocker arm.

3. The suspension system of claim 1 in which the lower pivot member comprises a rocker arm.

4. The suspension system of claim 1 in which the upper and lower pivot members are part of a wheel frame section that is coupled to the wheel axle and that defines upper and lower pivot points that are spaced from the wheel axle.

5. The suspension system of claim 4 in which the upper pivot member comprises an upper rocker arm pivotally coupled to the upper pivot point, pivotally coupled to the shock absorber, and pivotally coupled to the vehicle frame.

6. The suspension system of claim 4 in which the lower pivot member comprises a lower rocker arm pivotally coupled to the lower pivot point, pivotally coupled to the shock absorber, and pivotally coupled to the vehicle frame.

7. The suspension system of claim 4 in which the upper pivot member comprises an upper rocker arm pivotally coupled to the upper pivot point, pivotally coupled to the shock absorber, and pivotally coupled to the vehicle frame, the lower pivot member comprises a lower rocker arm pivotally coupled to the lower pivot point, pivotally coupled to the shock absorber, and pivotally coupled to the vehicle frame, and in which the wheel frame section further comprises a swing arm between the lower rocker arm and the wheel axle, and a shock stay located above the swing arm and between the upper rocker arm and the wheel axle.

8. The suspension system of claim 5 in which the upper rocker arm is coupled to the vehicle frame at a location that is above that of the upper pivot point.

9. The suspension system of claim 5 in which the location at which the upper rocker arm is coupled to the vehicle frame is below the location at which the upper rocker arm is coupled to the shock.

10. The suspension system of claim 5 in which the location at which the upper rocker arm is coupled to the vehicle frame is between the locations where it is coupled to the upper pivot point and where it is coupled to the shock absorber.

11. The suspension system of claim 5 in which the upper rocker arm rotation in one direction about its pivot on the vehicle frame causes compression of the shock.

12. The suspension system of claim 6 in which the lower pivot point is below the location at which the lower rocker arm is coupled to the vehicle frame.

13. The suspension system of claim 6 in which the location at which the lower rocker arm is coupled to the shock is between the locations where it is coupled to the lower pivot point and where it is coupled to the vehicle frame.

14. The suspension system of claim 6 in which the lower rocker arm rotation in one direction about its pivot on the vehicle frame causes compression of the shock.

15. The suspension system of claim 6 in which the rotation of the lower rocker arm relative to the vehicle frame is limited by its contact with the vehicle frame.

16. The suspension system of claim 6 in which the lower rocker arm has three pivots that define a triangle.

17. The suspension system of claim 6 in which the shock is coupled to the lower rocker arm closer to the wheel than the location at which the lower rocker arm is coupled to the vehicle frame.

18. The suspension system of claim 7 in which downward force by the shock rotates the lower rocker arm about the vehicle frame pivot and pulls the swing arm forward.

19. The suspension system of claim 4 in which the upper pivot member comprises an upper rocker arm pivotally coupled to the upper pivot point, pivotally coupled to the shock absorber, and pivotally coupled to the vehicle frame, the lower pivot member comprises a lower rocker arm pivotally coupled to the lower pivot point, pivotally coupled to the shock absorber, and pivotally coupled to the vehicle frame, and in which the wheel frame section further comprises a parallel bar pivoting linkage between the vehicle frame and the lower rocker arm.

20. The suspension system of claim 19 in which the wheel frame section further comprises a connecting rod connecting the parallel bar linkage to the upper rocker arm.

21. A compressible link suspension system for a wheel of a multi-wheel vehicle that has a frame and an axle for the wheel, comprising:
a wheel frame section that is coupled to the wheel axle and that defines upper and lower pivot points that are spaced from the wheel axle, and comprising upper and lower rocker arms coupled to the wheel axle, that isolate the rear wheel from the frame, in which the upper rocker arm is pivotally coupled to the upper pivot point, pivotally coupled to the shock absorber, and pivotally coupled to the vehicle frame, and the lower rocker arm is pivotally coupled to the lower pivot point, pivotally coupled to the shock absorber, and pivotally coupled to the vehicle frame, the wheel frame section further comprising a swing arm between the lower rocker arm and the wheel axle, and a shock stay located above the swing arm and between the upper rocker arm and the wheel axle; and
a shock absorber connected between the rocker arms;
in which the location at which the upper rocker arm is coupled to the vehicle frame is between the locations where it is coupled to the upper pivot point and where it is coupled to the shock absorber, and in which the location at which the lower rocker arm is coupled to the shock is between the locations where it is coupled to the lower pivot point and where it is coupled to the vehicle frame.

22. A suspension system for a wheel of a multi-wheel vehicle that has a frame, comprising:
a wheel frame section assembly coupled to the wheel axle, and defining upper and lower connection points that are spaced from the wheel axle;
a shock absorber;
an upper actuator coupled to the upper connection point and also coupled to the shock absorber, the upper actuator adapted to compress the shock absorber in a first direction; and
a lower actuator coupled to the lower connection point and also coupled to the shock absorber, the lower actuator adapted to compress the shock absorber in a second direction.

23. A compressible link suspension system for a wheel of a multi-wheel vehicle that has a frame and an axle for the wheel, comprising:
pivoting structure coupled to the wheel axle that isolates the rear wheel from the frame; and
a shock absorber connected between spaced portions of the pivoting structure;
wherein the pivoting structure is adapted to compress the shock from two directions.

24. The suspension system of claim 23 in which the pivoting structure and shock are adapted to allow the wheel to move both up and down, and backward and forward, relative to the frame.

25. The suspension system of claim 24 in which, when the wheel encounters an abrupt obstruction, the wheel moves both backward and up simultaneously such that the wheel axle traverses a first arcuate path, from a beginning point to an end point.

26. The suspension system of claim 25 in which, when the wheel has passed over the abrupt obstruction, the wheel moves both forward and down simultaneously such that the wheel axle traverses a second arcuate path, from the end point to the beginning point.

27. The suspension system of claim 26 in which the first and second arcuate paths are not coincident, and together define a closed, generally elliptical shape.
